(19) United States
(12) Patent Application Publication
(10) Pub. No.: US 2024/0118759 A1
(43) Pub. Date: Apr. 11, 2024

(54) TOUCH DISPLAY

(71) Applicant: LUMINEQ OY, Espoo (FI)

(72) Inventor: Jussi PIRKKALANIEMI, Espoo (FI)

(73) Assignee: Lumineq Oy, Espoo (FI)

(21) Appl. No.: 18/265,392

(22) PCT Filed: Dec. 17, 2021
(86) PCT No.: PCT/FI2021/050890

§ 371 Date: Jun. 5, 2023

(30) Foreign Application Priority Data
Dec. 18, 2020 (FI) 20206335

(51) Int. Cl. G06F 3/041; G09G 3/12

(52) U.S. Cl. CPC G06F 3/0412; G06F 3/04164; G06F 3/04166; G06F 3/0418; G09G 3/12; G06F 3/044; G06F 2203/04107; G09G 2354/00

(57) ABSTRACT

A touch display (100) is disclosed. In the invention, a touch connection (271) is provided between the touch measurement node (205) and the segment display electrode (107), arranged to provide a touch measurement signal (205s) for touch detection to the segment display electrode (107). The touch connection (271) comprises an isolator (272) arranged to isolate the segment driving signal (215s) of the segment display electrode (107) from the touch measurement unit (200). The touch display (100) also comprises a shield connection (187) between the shield signal node (206) of the touch measurement unit (200) and the driving electronics ground node (110) of the driving electronics unit (210) arranged to connect the shielding voltage signal (206s) to the driving electronics ground node (110).

### FIELD OF THE INVENTION

The present invention relates to touch displays, and more particularly to a touch display according to the preamble of claim 1.

### BACKGROUND OF THE INVENTION

Touch displays are getting more and more commonplace in making a two directional user interface for various devices and structures, enabling both user input and output to the user. For example, in mobile phones, touch displays are currently ubiquitous. Also displays that are integrated into the external windows in vehicles like cars and tractors are getting more and more commonplace. For example, it is possible to laminate a transparent window to the windshield of a tractor for the indication of various states and warning conditions related to the operation of the tractor. Also projected HUDs are well known in the marketplace.

With touch sensing capability, the display becomes a two-way interface for the user. One example of a use case of such a touch display is a so-called pin-pad application where a keyboard with numbers 0-9 and some additional marks like hash (“#”) and asterisk (“*”) are combined with a display. Such a touch display can be integrated into the side window of a car, enabling keyless entry to the vehicle as the user can be granted access when a correct PIN number is entered. A laminated window-pane of a vehicle is a very advantageous location for a touch display. When located into the interlayer of a two-ply laminate or in a recess in the interlayer, the display is very well protected from the environment, mechanical wear and tear, and other impacts. Naturally, the touch display (which is usually a glass or plastic substrate on which a complex thin film structure is fabricated and comprising electric connections usually in a form of an FPC (flexible printed circuit) or other flat cable) or at least portions of it has to be able to withstand the glass lamination manufacturing process step that reaches easily a 140 C temperature and a 10 bar pressure. Usually, the display also comprises driving and sensing electronics creating the light producing signals, sense the touch events and communicate with other electrical systems with input and output signals. Electronics part is usually left out of the laminate. At the same time, the laminated window and laminated display therein must fulfil the relevant standards and safety aspects for vehicle glazings, e.g. standards related to the transparency and shattering characteristics.

One of the problems associated with the prior art is related to the use conditions of a touch display integrated into an external vehicle window, e.g. car side window. Touch event is registered in the prior art technology usually with capacitive sensing in which a chance in a coupling capacitance or self-capacitance of an electrode or electrodes is detected. Said change is invoked by the presence of an operator touching, usually with his or her finger or fingers, the touch display. Human tissue is complex combination of electrically conducting and insulating microscopic and macroscopic regions, with different, usually frequency dependent permittivity and conductivity. However, unfortunately from the perspective of the touch detection, water resembles human tissue in the electromagnetic sense. Thus, a drop or a splash of water on the top of the touch display is difficult to tell apart from the real touch event by the user of the display. Also other exposures like mud, dirt, snow or slush or any combination thereof on top of the display are difficult to distinguish from real user touch interaction. Ability to distinguish between real user touch and environmental exposure is usually called “immunity” in the art, and as most of the environmental exposure is due to drops, streams, ropes or splashes of liquid water on top of the touch display, this ability is called “water immunity” even though the exposure can be due to e.g. dirt or slush, too. As part of a good water immunity, true touch events are recognized even in presence of environmental factors on top or in the immediate vicinity of the touch display.

Due to its robust nature, the AC driven thin film electroluminescent display (“AC TFEL” or “AC TFEL display”) is a leading technology when integrating displays inside various window structures, e.g. laminated vehicle windshields and side windows. For the purposes of glass integration, these displays are predominantly segment type displays, where the information is shown to the user with prefabricated symbols or areas, and turning light emission from the areas on or off. Such a symbol may be e.g. warning sign or a number, or a portion of a number e.g. in a so-called seven-segment numeric display. Light emission occurs from an area of an overlap of a segment display electrode and common display electrode. Naturally, for glass integration the display is also advantageously transparent. When a touch is integrated to this kind of display, in the prior art, separate touch electrodes and segment and common display electrodes have been used. This, however, creates problem in routing the connections between the electrodes and the pad area of the display panel as there are many touch electrodes, segment display electrodes and common display electrodes to connect, and it is not easy to reliably create bridge and via structures into the thin film structure of an AC TFEL.

Good water immunity is not easy to achieve. In the prior art, related solutions are difficult to arrange, involve complex structures or complex method steps in their operations, and increase the overall cost and energy consumption of the touch display. Further, placing many touch electrodes and many segment display electrodes and common display electrodes into the display creates routing problems in the design of the display for routing the interconnecting traces that may not overlap in many electroluminescent technologies.

Thus, there is a need to improve the water immunity of a touch display, especially when the touch display is integrated into the exterior of a vehicle, e.g. laminated into an external window of the vehicle. As the routing of the connections between the connection area and the electrodes gets challenging due to more complex display designs, there is also a need to utilize the electrodes of the display more effectively and maintain water immunity.

### BRIEF DESCRIPTION OF THE INVENTION

An object of the present invention is to provide a touch display with improved water immunity and improved electrode utilization. In particular, the objects of the invention are achieved by a touch display according to the independent claim 1.

The preferred embodiments of the invention are disclosed in the dependent claims.

As an aspect of present invention, a touch display is disclosed. The touch display comprises a thin film display element extending substantially along a base plane defining a lateral extension of the thin film display element. The thin film display element comprises an emissive layer arranged to emit light upon an excitation voltage is arranged over the emissive layer, a first patterned conductor layer on a first side of the emissive layer, the first patterned conductor layer comprising a segment display electrode, a second patterned conductor layer on a second side of the emissive layer opposite the first side of the emissive layer, the second patterned conductor layer comprising a common display electrode at least partly laterally overlapping the segment display electrode. The touch display also comprises a driving electronics unit. The driving electronics unit comprises a segment driving node arranged to produce a segment driving signal to the segment display electrode, a common driving node arranged to produce a common driving signal to the common display electrode, and a driving electronics ground node. The touch display also comprises a touch measurement unit. The touch measurement unit comprises a touch measurement node arranged to provide a touch measurement signal for touch detection, a shield signal node arranged to provide a shielding voltage signal arranged to decrease capacitive coupling, and a touch ground node. The touch display also comprises a segment connection arranged to electrically connect the segment display electrode and the segment driving node, a common connection arranged to electrically connect the common display electrode and the common driving node, and an earth ground node. According to the invention, the touch display comprises a touch connection between the touch measurement node and the segment display electrode, the touch connection arranged to provide a touch measurement signal for touch detection to the segment display electrode, the touch connection comprising an isolator arranged to isolate the segment driving signal of the segment display electrode from the touch measurement unit. The touch display also comprises a shield connection between the shield signal node of the touch measurement unit and the driving electronics ground node of the driving electronics unit, the shield connection arranged to connect the shielding voltage signal to the driving electronics ground node.

In an embodiment, the isolator of the touch connection comprises a switch.

In another embodiment, the isolator of the touch connection comprises a switch which is arranged be set into an open state during light emission periods and arranged to isolate the segment driving signal of the segment display electrode from the touch measurement unit during light emission periods, and set into a closed state during touch measurement periods and arranged to connect the touch measurement signal for touch detection to the segment display electrode during touch measurement periods.

In an embodiment, the touch display comprises a control unit arranged to control the driving electronics unit, the touch measurement unit and the switch.

In an embodiment, the touch display comprises a control unit such that: a) the driving electronics unit, as controlled by the control unit, is arranged to produce the segment driving signal to the segment display electrode and a common driving signal to the common display electrode for light emission during light emission periods, b) the touch measurement unit, as controlled by the control unit, is arranged to produce, during touch measurement periods, the touch measurement signal to the segment display electrode for touch detection, and the shielding voltage signal, and c) the switch, as controlled by the control unit, is arranged to be set into an open state during light emission periods and arranged to isolate the segment driving signal of the segment display electrode from the touch measurement unit, and into a closed state during touch measurement periods to connect the touch measurement signal for touch detection to the segment display electrode.

In an embodiment, the isolator of the touch connection comprises a capacitor with a capacitance value of at least 5 μF (pico-Farads).

In another embodiment, the isolator of the touch connection comprises a capacitor with a capacitance value between 1 μF and 1 μF (micro-Farads). In another embodiment, the isolator of the touch connection comprises a capacitor with a capacitance value between 10 μF and 100 nF (nano-Farads).

In yet another embodiment, the isolator of the touch connection comprises a capacitor with a capacitance value between 100 μF and 10 nF.

In an embodiment, the first patterned conductor layer on the first side of the emissive layer comprises a first fill area, and the touch display comprises a first fill connection arranged to connect the shielding voltage signal to the first fill area.

In an embodiment, the second patterned conductor layer on the second side of the emissive layer comprises a second fill area, and the touch display comprises a second fill connection arranged to connect the shielding voltage signal to the second fill area.

In an embodiment, the touch display comprises an amplifier arranged to amplify the shielding voltage signal.

In an embodiment, the touch display comprises an operational amplifier arranged to amplify the shielding voltage signal.

In an embodiment, the touch display comprises an operational amplifier arranged as a unity gain buffer arranged to lessen the power drawn by the shielding voltage signal from the touch measurement unit.

In an embodiment, the first patterned conductor layer comprises one or more segment display electrodes, the driving electronics unit comprises one or more segment driving nodes, the touch measurement unit comprises one or more touch measurement nodes, the touch display comprises one or more segment connections arranged to electrically connect the one or more segment display electrodes and the one or more segment driving nodes, and the touch display comprises one or more touch connections between the one or more touch measurement nodes and the one or more segment display electrodes arranged to provide touch measurement signals for touch detection to the one or more segment display electrodes.

In an embodiment, the second patterned conductor layer comprises one or more common display electrodes, the driving electronics unit comprises one or more common driving nodes, and the touch display comprises one or more common connections arranged to electrically connect the one or more common display electrodes and the one or more common driving nodes.

In an embodiment, the first patterned conductor layer and the second patterned conductor layer are transparent.

In another embodiment, the thin film display element is transparent.

In an embodiment, the touch display is an AC driven thin film electroluminescent (“TFEL”) touch display.

The invention is based on the idea of providing the touch display with an arrangement that provides so-called shield signal or shielding voltage signal to the driving electronics ground node, and of providing a connection from one or more touch electronics measurement nodes to one or more segment display electrodes. Thus, the segment display electrodes can be arranged to act also as touch electrodes, which cuts down the required number of electrodes in the display panel. This, in turn, makes the routing of the traces between the contact area of the display panel and the electrodes easier, especially if the touch display is an AC driven TFEL touch display.

An advantage of the invention is also that the water immunity of the touch display is considerably improved with a feasible circuit topology that does not affect other functions of the display negatively. At the same time, routing the traces of the display between the contact area of the glass panel and segment display electrodes and common display electrodes is considerably simpler, as there are potentially no separate touch electrodes that would need routing.

### BRIEF DESCRIPTION OF THE DRAWINGS

The invention is described in detail by means of specific embodiments with reference to the enclosed drawings, in which

FIG. 1 shows schematically a prior art touch display and its peripheral objects,

FIG. 2 shows schematically a touch display according to an embodiment of the invention,

FIG. 3 shows schematically a touch display according to another embodiment of the invention,

FIG. 4 shows schematically a touch display according to yet another embodiment of the invention,

FIG. 5 shows schematically a touch display according to another embodiment of the invention,

FIG. 6 shows schematically a touch display according to another embodiment of the invention, and

FIG. 7 shows schematically a touch display according to yet another embodiment of the invention.

### DETAILED DESCRIPTION OF THE INVENTION

In the following description, like numbers (e.g. 20) or labels (e.g. 21a) denote like elements. The following definitions also apply in the present application throughout:

In the present application, a “display” means an electronic device configured to present data, state or imagery. The display is arranged to display various patterns as pixels, images, or text, but also, for example, indicator displays or user interface elements with at least one emissive area for light emission from the emissive area. In other words, a “display” is arranged to output information through light emission.

In the present application, a “display panel” means the portion of the display which comprises at least one light emissive area like overlapping segment and common display electrodes, arranged on a substrate which determines the lateral extension of the display panel.

In the present application, a “touch display panel” means the portion of the display which comprises the at least one light emissive area like overlapping segment and common display electrodes, and an electrode arranged for touch sensing, which may be a segment display electrode.

In the present application, a “touch display” means a display arranged, in addition to displaying information, to detect user interaction with the display in form of touch or close vicinity relative to the touch display, by part of the body of the user (e.g. finger or elbow) or by a peripheral like a stylus. Thus, a display and a touch display comprise also the required electronics, interconnecting and interfacing units in addition to the display and touch display panel, respectively.

In the present application, a “touch” means any change in distance between a pointing object, such as a finger of the user of the touch display, and an electrode arranged for touch sensing resulting in a detectable change in self-capacitance between said pointing object and the touch sensing electrode, or a detectable change in coupling capacitance between two electrodes caused by the pointing object in the vicinity of the two electrodes. Usually a “touch” means bringing the pointing object to a close proximity to the touch electrode causing said change in the capacitance, e.g. a situation where only an insulator over the display panel like the interlayer film and glass ply separate the pointing object and the electrode. Such a separation can be, for example 0.5 mm-3 mm. As such, “touch sensing” may herein refer to touch and/or proximity sensing.

In the present application, a “display arrangement” refers to an arrangement which may form a complete, operable display. Alternatively, a display arrangement may be used as a part of a complete display comprising also other elements, units, and/or structures. A display arrangement may generally comprise at least one display element.

In the present application, a “display element” refers to an element comprising at least one emissive area for emitting light therefrom to present visual information.

In the present application, a “during a period” means that an event takes place or occurs during a period of time, but the occurrence does not have to span the entire duration of the period of time.

In the present application, “light” refers to electromagnetic radiation of any wavelength(s) within a range of relevant wavelengths. The range of relevant wavelengths may overlap or coincide with ultraviolet (wavelength from about 10 nanometres (nm) to about 400 nm), visible (wavelength from about 400 nm to about 700 nm), and/or infrared (wavelength from about 700 nm to about 1 millimetre (mm)) parts of electromagnetic spectrum.

In the present application, a “layer” means a generally sheet-formed element arranged on a surface or a body. A layer can also refer to one of a series of superimposed, overlaid, or stacked generally sheet-formed elements. A layer may generally comprise a plurality of sublayers of different materials or material compositions. A layer may be path-connected or joined in terms of their areas. Some layers may be locally path-connected and disconnected and have one or more holes.

In the present application, a “base plane defining the lateral extension of the thin film display element” means that the display element has lateral directions along said base plane. Lateral directions of said element usually have dimensions substantially larger than in a thickness direction perpendicular to said lateral directions.

In the present application, a “thin film display element” refers to a display element comprising layers that have thicknesses, for example, in a range from a few nanometres to some hundreds of nanometres or some micrometres. The thin film display element may also comprise a substrate, substrate usually comprising glass or ceramic material, on top of which the thin films are deposited or otherwise arranged. The thin film display element may also comprise a cover glass on the other side of the substrate.

In the present application, an “emissive layer” refers to layer comprising material capable of emitting light when a driving signal or driving voltage is arranged over said emissive layer. Here, “over the emissive layer” means that a voltage is applied between the two surfaces of the emissive layer. Said application of voltage is usually arranged by light producing electrodes, in particular one or more segment display electrodes and one or more common display electrodes arranged on opposite sides of the emissive layer so that a segment display electrode and a common display electrode at least partially overlap along a base plane defining the lateral extension of the thin film display element.

In the present application, an “excitation voltage” means a high enough voltage to achieve a wanted level of light emission from the emissive layer. An excitation voltage in the thin film inorganic electroluminescent displays (also called “TFEL displays”, or “TFELs”) is in the order of 50V-250V in amplitude, and comprise pulses or, in general, AC (alternating current and voltage) excitation. For OLED (organic led) displays, another important class of emissive displays comprising thin films, the excitation voltage is usually in the range of 2-10V only.

In the present application, a “conductor” may mean an electrical conductor material and/or the electrical conductivity thereof and/or a physical shape (e.g. line or trace) of substantially electrically conducting material. Consequently, a “conductor layer” means a layer comprising a conductor material. A conductor may also mean a cable, e.g. a flat cable or flat printed circuit suitable of conveying one or more voltage or current signals with suitable insulators between the conductive traces or wires.

In the present application, the concept of “transparent” means a quality, i.e., “transparency”, of said element or material of allowing light of wavelength(s) within a range of relevant wavelengths to propagate through such element or material so that, for example, the sight of vision is not materially hindered with relation to the view behind the material, except for the areas behind the lit portions of the display. Said range of relevant wavelengths may generally depend on intended usage of such transparent element or material. No real material is 100% transparent as every physical material has at least small attenuating and reflective characteristics relative to an ideal free space. As a measure of transparency, a transparent display or a transparent touch display may have a photopic transparency of e.g. 20%-70%.

In the present application, a “light electrode” or “light producing electrode” means an electrode, usually a planar conductive, thin area or “patch” arranged for coupling electrical voltage or driving signal over an emissive layer for light emission. A display electrode may be functionally, electrically, and/or galvanically connected to a display driver unit for the coupling of said electrical voltage. A display electrode may at least partly or entirely overlap another display electrode laterally to arrange electrical voltage over an emissive layer. Common display electrodes and segment display electrodes are both light producing electrodes as their overlapping area, when supplied with a driving signal, produces light according to the principles of TFEL displays.

In the present application, a “self-capacitance” of an element means a physical quantity of a non-insulating body, for example an electrode, indicative of a ratio between added electrical charge in said body and an increase in electrical potential or voltage of said body. Measurement of self-capacitance may be referred to as measurement of capacitance with respect to infinity. In practice, measurement of self-capacitance may refer to measuring capacitance with respect to an electrical ground potential, e.g., earth ground.

In the present application, a “shielding voltage signal” means a signal, which may be time-dependent and when fed to a circuit node like a conductor area, is arranged for decreasing capacitive coupling between an electrode arranged for touch sensing and another conductor area. Such another conductor area may be e.g. another electrode. Additionally or alternatively, a shielding voltage signal may refer to a signal with a sufficient cross-correlation with a touch measurement signal. In practice, supply of measurement and shielding voltage signals by a touch measurement unit is described in more detail below. Suitable signal types may generally depend on a variety of factors, including thin film display element type, structure of the emissive layer, and economical considerations. In some embodiments, sinusoidal and/or square voltage signals or square pulse trains or bursts may be used as measurement and/or shielding voltage signals.

In the present application, “an electric connection” or “electrical connection” or “be electrically connected” means that two circuit nodes or two circuit elements are arranged to be interconnected purposefully, with not just a parasitic coupling between the circuit nodes or circuit elements. The electrical connection may comprise other active or passive circuit elements or components in series or in parallel. An electrical connection may also be a short circuit or a low-impedance coupling or a galvanic connection between the two circuit nodes or two circuit elements.

In the present application, a “connection” or “be connected”, unless otherwise specified or clearly can be otherwise determined from the circumstances of the usage of the term, means an “electrical connection” or an “electric connection”.

In the present application, a “node” or a “circuit node” means the electric circuit theory concept of a conducting region having essentially the same potential or voltage, e.g. between at least two circuit elements. E.g. a conductor (e.g. a copper wire in an FPC) connected to a driving circuit node are the same driving circuit node as the driving circuit node determines the voltage of the conductor throughout the region of the conductor.

In the present application, a “fill area” means a conducting area of arbitrary shape on the first patterned conductor layer or on the second patterned conductor layer of the thin film display element, or on both layers. A fill area is not connected to the driving electronics unit for light production purposes. A fill area remains void of light production. There can be one or more fill areas in the thin film display element of the touch display. In other words, a fill area is not connected to a segment driving node, or to a common driving node for light production purposes. Purpose of the fill area is to make the first patterned conductor layer and the second patterned conductor layer appear optically more uniform. One or more fill areas may be arranged to fill most of the regions of the gaps between the light producing segment electrodes on the first patterned conductor layer, and most of the regions of the gaps between the light producing common electrodes on the second patterned conductor layer. Fill areas must not short circuit two neighbouring segment electrodes on the first patterned conductor layer or two neighbouring common electrodes on the second patterned conductor layer, however.

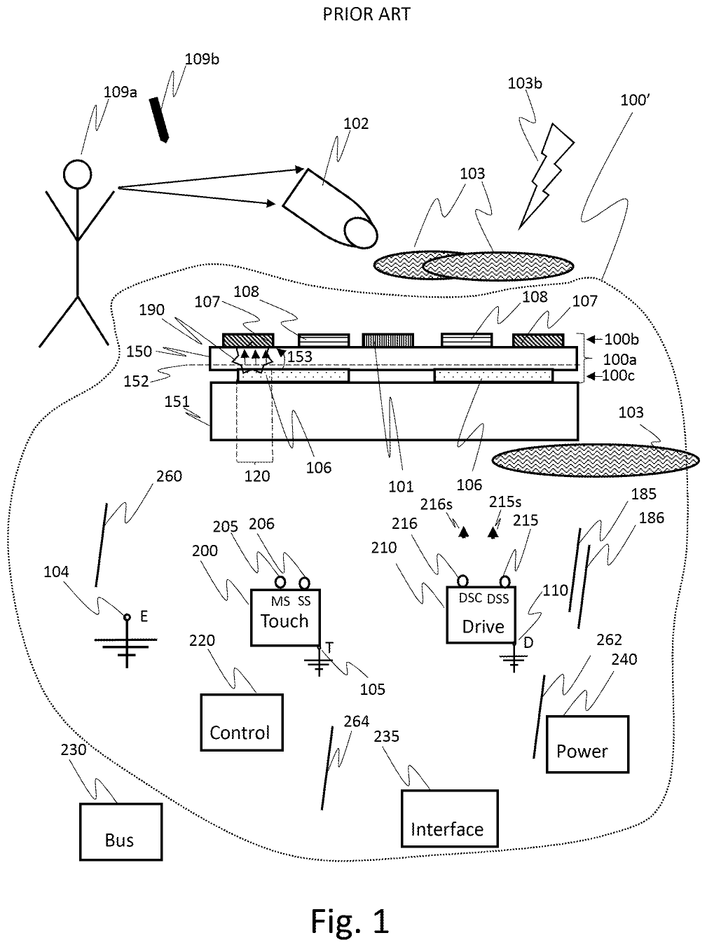

FIG. 1 shows basic units in a prior art touch display 100′ schematically.

The prior art touch display 100′ comprises a substrate 151 and a thin film structure comprising one or more common display electrodes 106, one or more segment display electrodes 107, an emissive layer 150 that, when suitably excited with voltage over the emissive layer (shown with voltage difference 153), emits light 190 at the lateral overlap 120 of the two electrodes providing the excitation (here, as an example, a segment display electrode 107 and a common display electrode 106), one or more fill areas 108 and one or more touch electrodes 101. Emissive layer may comprise e.g. manganese doped zinc sulfide (ZnS:Mn). Dimensions of the units in FIG. 1 are exaggerated as the thickness of the various electrodes and emissive layer are several orders of magnitude smaller than the thickness of the substrate. Light emission 190 occurs when light producing electrodes (that is, at least one common display electrode 106 and at least one segment display electrode 107) are at least partially arranged to overlap in the lateral direction (segment display electrode 107 and common display electrode 106, as shown), relative to one another, and when the common electrodes 106 and segment electrodes 107 are fed with a common driving signal 216s and a segment driving signal 215s, respectively. The segment driving signal 215s and the common driving signal 216s each have voltage and current characteristics arranged to excite the emissive layer for light emission 190 or leave it dark, depending on the information displaying task at hand. Driving signals are generated by driving electronics unit 210, and each of the light producing electrodes, common display electrodes 106 and segment display electrodes 107, is connected to the drive electronics with suitable connections 186 and 185, respectively. Thus, a driving signal for an overlapping area of a segment display electrode 107 and a common display electrode 106 is the voltage difference 153 of the segment driving signal 215s and common driving signal 216s fed to the respective electrodes.

If the first patterned conductor layer 100b (and its segment display electrodes 107) and the second patterned conductor layer 100c (and its common display electrodes 106) of the thin film display element 100a are transparent, e.g. arranged of a transparent conductive oxide like indium doped tin oxide (“ITO”), the display is transparent.

It is also possible to arrange the first patterned conductor layer 100b (and its segment display electrodes 107) or the second patterned conductor layer 100c (and its common display electrodes 106) of a non-transparent conductive material like thin layer of aluminium. In this case, the display is not transparent as one of its constitutive thin films is not transparent.

In TFEL displays, a first electric insulator layer between the segment display electrodes 107 and the emissive layer 150 is usually provided. Similarly, in TFEL displays, a second electric insulator layer between the common display electrodes 106 and the emissive layer 150 is usually provided. First and second electric insulator layers (not shown) are provided to block a high direct current running which would likely ruin the display. First and second insulator layers are usually transparent, as is the emissive layer 150. Thus, the transparency of the display is determined mostly by the properties of the electrode layers (that is, first and second patterned conductor layers 100b and 100c, respectively). Emissive layer 150 and first and second electric insulator layers are preferably arranged with the ALD (atomic layer deposition) method. Emissive layer 150 may comprise e.g. manganese doped zinc sulfide, and first and second insulator layers may comprise e.g. a stratified aluminium oxide-titanium oxide nanolaminate for a very good electrical insulation.

The prior art touch display 100′ may also comprise one or more fill areas 108. Purpose of the fill area 108 is to improve the optical appearance and uniformity of the display. Electrodes (for example, light producing electrodes 106 and 107 and other possible electrodes) are thin film structures and they do not cover the entire surface area of the display. Transmission and reflectivity at the areas with electrodes and at the areas with no electrodes differ, making the display surface appear nonuniform. This problem can be corrected to a large degree by deposition (or if the layer is patterned with etching, non-etching) of one or more fill areas 108 that are not fed with driving signals and are as inert as possible from the standpoint of electrical operation of the display, but from the material and optical point of view correspond or appear like electrodes and are provided from the same conductive material as electrodes, e.g. ITO. In other words, a fill area 108 is not connected to a segment driving node 215, or to a common driving node 216 for light production purposes. However, as will be discussed later in the present application, the fill areas act as (parasitic) capacitors in the overall system of the display as they comprise mostly conductive material just as the other electrodes do. Fill areas 108 may be arranged on both the first patterned conductor layer 100b and on the second patterned conductor layer 100c.

Still referring to FIG. 1, in the prior art, a touch event can be detected when a part, here a finger 102, of the user body is brought to the proximity of a touch electrode 101. Detection is based on the change of capacitance of the touch electrode 101 caused by the introduction of finger 102 into the vicinity. The finger 102 can be seen to introduce a parallel capacitor to the system of the touch electrode 101 originally having a certain capacitance relative to its surroundings, thus increasing the sensed self capacitance of the touch electrode 101. With a suitable touch measurement unit 200 and measurement signals generated by the touch measurement unit or touch sensing electronics, this change can be detected. Detection of the change in capacitance requires that the sensing electrode is connected with suitable connections 260 to the touch sensing electronics and its measurement node or nodes 205 (to simplify FIG. 1, exact connections between the different units is not shown). For each of the touch electrodes 101, a separate connection 260 and a separate measurement node 205 in the touch measurement unit 200 may be provided. It is to be noted that in the prior art touch display 100′, the touch electrode 101 is a separate electrode from the segment display electrode 107 and the common display electrode 106 and is not arranged to be connected to the driving electronics unit 210 with connections 186 and 185 as its purpose is not, in the prior art, light production.

Challenge with prior art is also that many environmental exposures like splashes of water, mud or slush, shown with symbol 103, can also find their way to the surface of the touch display and also alter the capacitance of the touch electrode 101. Similarly, spurious electromagnetic fields around the touch display, represented with symbol 103b, can be interpreted as a change in capacitance of the touch electrode, leading to a false touch sensing and wrong consequences based on the interpretation of the false touch. For a display panel laminated into a vehicle exterior window, the environmental exposure can naturally occur from the outside of the vehicle, but such exposure is also theoretically possible from the inside of the vehicle e.g. if rainwater seeps into the car cabin and onto the inside surface of a side window of a car, or a drink is spilled on the side window by accident.

Interaction with the touch display can be performed with any part of the user body 109a, like finger 102, or with a stylus 109b held and operated by the user.

For a skilled person it is evident that the prior art touch display 100′ comprises a power unit 240 that supplies the power to the operations of the touch display 100. Power supply is provided with suitable connections 262 to connect the power to the other energy consuming units of the prior art touch display 100′. The prior art touch display 100′ comprises also an interface unit 235 which communicates in a two-way sense with both input and output with the system units external to the prior art touch display 100′ through some communication bus 230. In the present application, an interface unit 235 means both the physical connector like RJ45 and the related communication protocol like CanBUS, RS485, SPI or I2C. Similarly, communication bus 230 means both the conductors and cabling of the communication bus 230, and the logical protocol like CanBUS or RS485 carried by the conductors and cabling. The operation of the touch display can be controlled by a control unit 220, which is arranged in connection with other units like touch measurement unit 200, driving electronics unit 210, interface unit 235 and power unit 240 with suitable connections.

It is evident for a skilled person that the touch measurement unit 200, driving electronics unit 210, control unit 220, interface unit 235 and power unit 240 can be separate physical entities with their own housing or real estate in a printed circuit board and realized with discrete circuit components. Alternatively or additionally, the touch measurement unit 200, driving electronics unit 210, control unit 220, interface unit 235 and/or power unit 240 can be arranged with known integrated circuit technologies into a semiconductor chip, and/or realized programmatically through e.g. ASIC, FPGA and/or microprocessor and memory technologies. Usually the driving electronics unit 210 and the touch measurement unit 200 are separate as they may be sourced independently from different vendors.

In the present application, a shielding voltage signal is a signal or voltage waveform that is sufficiently “similar” to the touch measurement signal in its voltage behaviour. By exciting two conductive areas side by side, like an electrode and a fill area side by side, with same or similar voltages, there is no or only a small electric field between the two conductive areas, or the electric field is at least reduced between the two conductive areas. Thus, the two electrodes become insensitive to one another and the change in permittivity near or over one electrode (due to introduction or removal of, for example, a finger, into the vicinity of the electrodes) does not change the electric field between the electrodes. Similarity of two signals can be stated accurately with a signal cross correlation coefficient cs. Signal cross correlation may be considered a measure indicative of shape or phase similarity between two signals.

A cross-correlation coefficient cs of two discrete time signals x[t] and y[t] (t=1 . . . n) can be defined as follows:

$$cs ( x , y ) = \frac{{\sum }_{i = 1}^{n} x [ i ] y [ i ]}{\sqrt{{\sum }_{j = 1}^{n} x [ j ] x [ j ] \times {\sum }_{k = 1}^{n} y [ k ] y [ k ]}} .$$

Under practical circumstances, many signals may be treatable as discrete-time signals. In case of continuous signals, a cross-correlation coefficient cs may be calculable by sampling said signals with a sufficiently high number of samples.

In the present application, the cross correlation between the touch measurement signal and the shielding voltage signal is at least 0.8, more specifically 0.99. In other embodiments, a signal cross-correlation coefficient may be less than 0.8, or at least 0.8, or at least 0.9, or at least 0.95. Said cross correlation may be determined e.g. as a voltage between two areas of the thin film structure (e.g. a segment display electrode 107 arranged to sense touch, and one fill area 108). Off-the-shelf devices and component sets arranged to generate a touch measurement signal and a shielding voltage signal to decrease capacitive coupling are commercially readily available e.g. from Microchip Inc, Analog Devices Inc and from Cypress Semiconductor Corporation in many forms, e.g. as Cypress Semiconductor Corporation's CY8C20x37 product family or as MTCH10x product family from Microchip Inc.

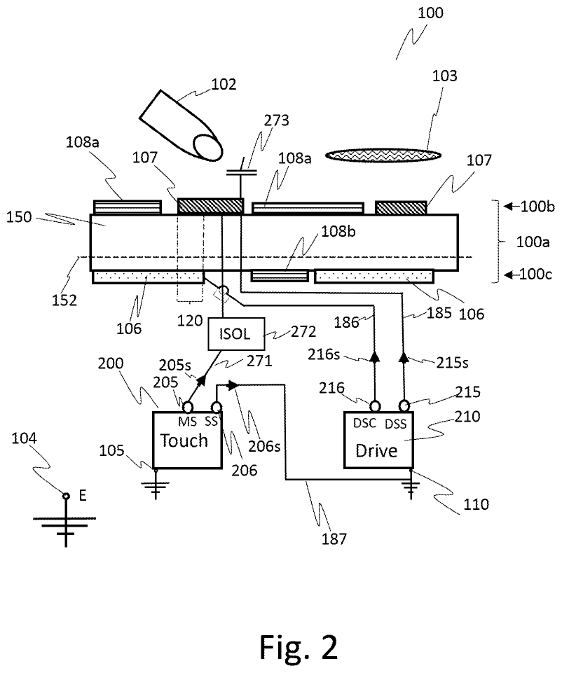

FIG. 2 shows an aspect of the present invention. A touch display 100 is shown in a sideways cutting plane view. The touch display 100 comprises a thin film display element 100a that extends substantially along a base plane 152. The base plane 152 is a fictitious plane that defines a lateral extension of the thin film display element 100a. The thin film display element 100a comprises an emissive layer 150 arranged to emit light upon an excitation voltage is arranged over the emissive layer 150 (that is, at least a portion of the excitation voltage spans from one surface of the emissive layer to the other surface of the emissive layer 150). The thin film display element 100a comprises also a first patterned conductor layer 100b on a first side of the emissive layer 150. The first patterned conductor layer 100b comprises a segment display electrode 107. The thin film display element 100a comprises also a second patterned conductor layer 100c on a second side of the emissive layer 150 opposite the first side of the emissive layer 150. The second patterned conductor layer comprises a common display electrode 106. The common display electrode 106 at least partly overlaps the segment display electrode 107 along the base plane 152, that is, laterally. An overlap is marked with label 120 in FIG. 2. In FIG. 2, the overlap is naturally shown in one dimension as the view is a cut-out view, but the practical implementation of the thin film display element 100a, the overlap is an area on the base plane 152. The thin film display element 100a may also comprise two dielectric layers or insulator layers around the emissive layer 150, one at each side and in connection to the emissive layer 150 to limit the current flowing through the emissive layer (the insulator layers are not shown in FIG. 2, however).

The concept of “patterned” means in the present application that the first and second patterned conductor layers may comprise several geometrical, essentially planar conductor shapes that may or may not be connected to one another, and may form a shape, e.g. a letter or a segment of a seven-segment display or a fill area. Also traces connecting the electrodes to the edges of the display element 100a for connection purposes are such patterns. The patterns can be arranged e.g. with lithographical and etching methods to a uniform conductor film arranged e.g. by sputtering.

The thin film display element 100a comprises an emissive layer 150 arranged to emit light when an excitation voltage is arranged over the emissive layer 150, between a segment display electrode 107 and a common display electrode 106. Emissivity can be achieved with certain doped inorganic materials like manganese doped zinc sulfide (ZnS:Mn) requiring a relatively high, alternating voltage behaviour. Voltage pulse amplitude can be e.g. 195V. Also organic materials can be used, and in this case the emissive layer can comprise a PN junction and operate along the principles of an organic LED (OLED), requiring low voltages (3V-10V) for excitation.

The first patterned conductor layer 100b comprises also a segment display electrode 107.

The thin film display element 100a also comprises a second patterned conductor layer 100c on a second side of the emissive layer 150 opposite the first side, comprising a common display electrode 106 at least partly laterally overlapping the segment display electrode 107. Overlap of the segment display electrode and common display electrode is shown with symbol 120 in FIGS. 2-7. Area and shape of the overlap determines the shape of the picture element, e.g. pixel in matrix displays, or a segment for segment displays where the information output is based on prefabricated forms of symbols or portions of symbols that are turned on or off.

Layers of the thin film display element 100a can be arranged on a substrate, e.g. deposited on a transparent soda lime glass substrate with thin film deposition techniques like chemical vapor deposition, atomic layer deposition and/or sputtering. A substrate is shown as element 151 in FIG. 1.

The touch display 100 also comprises a driving electronics unit 210. The driving electronics unit 210 comprises, in turn, a segment driving node 215 arranged to produce a segment driving signal 215s to the segment display electrode 107, a common driving node 216 arranged to produce a common driving signal 216s to the common display electrode 106, and a driving electronics ground node 110. The driving electronics ground node 110 is the zero reference potential of the driving electronics unit and has, in general, a different potential than the other ground nodes of the touch display 100, e.g. the touch ground node 105 of the touch measurement unit 200 or the earth ground node 104.

The touch display 100 comprises also a touch measurement unit 200 which comprises a touch measurement node 205 arranged to provide a touch measurement signal 205s for touch detection, and a shield signal node 206 arranged to provide a shielding voltage signal 206s. Shielding voltage signal 206s is arranged to decrease capacitive coupling especially between the conductive parts of the thin film display element 100a, e.g. a segment display electrode 107 and a common display electrode 106 during the touch detection. The touch measurement unit 200 comprises also a touch ground node 105.

The touch display 100 still comprises a segment connection 185 arranged to electrically connect the segment display electrode 107 and the segment driving node 215, and a common connection 186 arranged to electrically connect the common display electrode 106 and the common driving node 216. The touch display comprises also an earth ground node 104 which is the overall zero reference voltage of the touch display 100 and against which the other units, especially touch measurement unit 200 and driving electronics unit 210 may be capasitively coupled at least with parasitic capacitances.

Touch measurement signal 205s can be, for example, a train of voltage pulses at frequency f which is fed to the segment display electrode 107, and the capacitance Cₛₑₙₛₒᵣ, marked with label 273, of the electrode arranged for touch detection relative to its surroundings can be sensed as a change in an equivalent resistance R=1/(f Cₛₑₙₛₒᵣ). The touch measurement unit 200 can e.g. comprise a sigma-delta circuit the functionality of which is well known for those skilled in the art to detect a change in said equivalent resistance.

According to an aspect of the invention, the touch display 100 comprises a touch connection 271 between the touch measurement node 205 and the segment display electrode 107. The touch connection 271 is arranged to provide a touch measurement signal 205s for touch detection to the segment display electrode 107. The touch connection 271 comprises also an isolator 272 arranged to isolate the segment driving signal of the segment display electrode 107 from the touch measurement unit 200. The segment driving signal is arranged to the segment display electrode 107 with the segment connection 185. Isolator 272 may block the possibly high driving voltage (that may reach 200 V or −200 V or even higher) fed to the segment display electrode 107 from reaching the touch measurement unit 200. Such a high voltage could be detrimental to the operation of the touch measurement unit 200.

The touch display 100 also comprises a shield connection 187 between the shield signal node 206 of the touch measurement unit 200 and the driving electronics ground node 110 of the driving electronics unit 210. The shield connection 187 is arranged to connect the shielding voltage signal 206s to the driving electronics ground node 110.

Thus, the shield connection 187 arranges the feeding of the shielding voltage signal 206s to the driving electronics unit 210. From the driving electronics unit 210, the shielding voltage signal reaches the thin film display element 100a, and thus diminishes the capacitive effect of the environmental exposure 103 (like a splash of water), making a real touch of user 102 interacting with the segment display electrode 107 detectable. It has been found that the driving electronics ground node 110 of the driving electronics unit 210 is an advantageous connection point for the shield connection 187 in the driving electronics unit 210. Owing to the various capacitive parasitic paths, feeding shielding voltage signal to the ground node 110 of the drive electronics is an effective way to distribute shielding voltage signal to the thin film display element 100a. This effectively decouples the effects of the environmental exposures like water and dirt and makes the real touch detection considerably more error free and improves the immunity of the touch display system. The driving electronics ground node 110 is the circuit node of the driving electronics unit 210 relative to which the segment driving signals and common driving signals are measured in terms of their voltages.

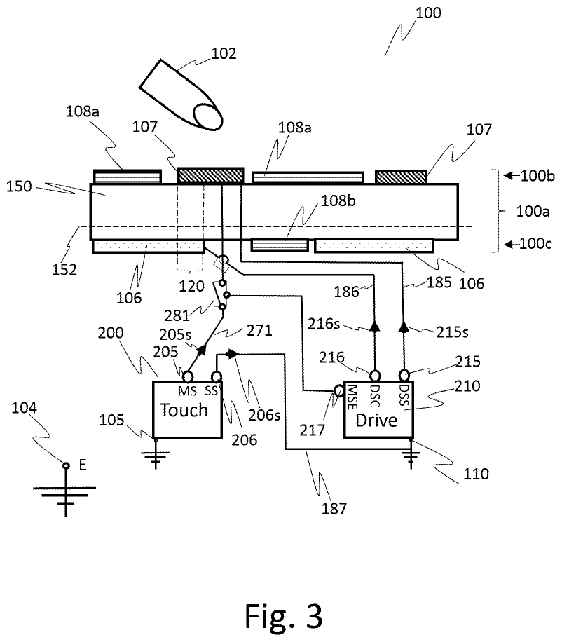

Turning to FIG. 3, in an embodiment, the isolator 272 of the touch connection 271 comprises a switch 281.

Still referring to FIG. 3, in an embodiment, the switch 281 is arranged be set into an open (non-conductive or high-impedance) state during light emission periods to isolate the segment driving signal 215s of the segment display electrode 107 from the touch measurement unit 200, and set into a closed (conductive or low-impedance) state during touch measurement periods to connect the touch measurement signal 205s for touch detection to the segment display electrode 107.

In another embodiment, the switch 281 is arranged be in an open (non-conductive or high-impedance) state during light emission periods to decouple the touch measurement signal 205s for touch detection from the segment display electrode 107, and in a closed (conductive or low-impedance) state during touch measurement periods to connect the touch measurement signal 205s for touch detection to the segment display electrode 107.

The operation of the touch display 100 may be arranged between light emission periods during which light emission from segment and common display electrodes occurs, and touch measurement periods during which touch detection and touch measurement occurs. Light emission periods and touch measurement periods alternate and repeat in time. During the touch measurement period, there is at least one period with no light emission. Similarly, the during light emission period, there is at least one another period with no touch measurement. A light emission period may be separated from a subsequent touch measurement period by a first guard period. A touch measurement period may be separated from a subsequent light emission period by a second guard period.

During each of the light emission periods, a segment driving signal 215s is arranged to one or more segment display electrodes through one or more segment driving nodes 215, and a common driving signal 216s is arranged to one or more common display electrodes through one or more common driving nodes 216. This produces light emission from the emissive layer, from the regions where one or more segment display electrodes and one or more common display electrodes overlap. During each of the touch measurement periods, a touch measurement signal is arranged to one or more touch measurement nodes 205 from which it is arranged to one or more segment display electrodes 107 for touch sensing. During each of the touch measurement periods, a shielding voltage signal is also arranged to one or more shield signal nodes 206 from which it may be arranged to the display electronics ground node 110, and in some embodiments e.g. to the fill areas 108a and 108b.

The switch 281 can be arranged in several ways, e.g. with a discreet enhancement type, N-channel MOSFET component (“FET”) which is arranged with a proper bias voltages, and the control of the switching (switch is conducting, that is, closed, or non-conducting, that is, open) is arranged to the gate node of the FET. A FET is in a conducting (closed) state between its drain and source nodes when suitably positive gate-source voltage is arranged to the gate node. As the switch 281 may be arranged into a non-conducting (open) state when the high driving voltage is arranged to the segment display electrode 107, the switch 281 can block the voltage, possibly detrimental to the touch measurement unit 200, from reaching the touch measurement unit 200.

Still referring to FIG. 3, in an embodiment, the control of the switch 281 is arranged from the driving electronics unit 210. The driving electronics unit 210 is an advantageous unit for controlling the switching of the switch 281 as the timing and synchronisation of driving the segment display electrodes and common display electrodes is inherent for the driving electronics unit 210, and the unit 210 may determine when light is produced and when light is not produced from a certain segment display electrode 107 and common display electrode 106 combination. The driving electronics unit 210 may also comprise a measurement enable node (MSE) 217, and the control of the switch 281 may be arranged from the measurement enable node (MSE) 217 to turn the switch 281 to a closed state and to an open state.

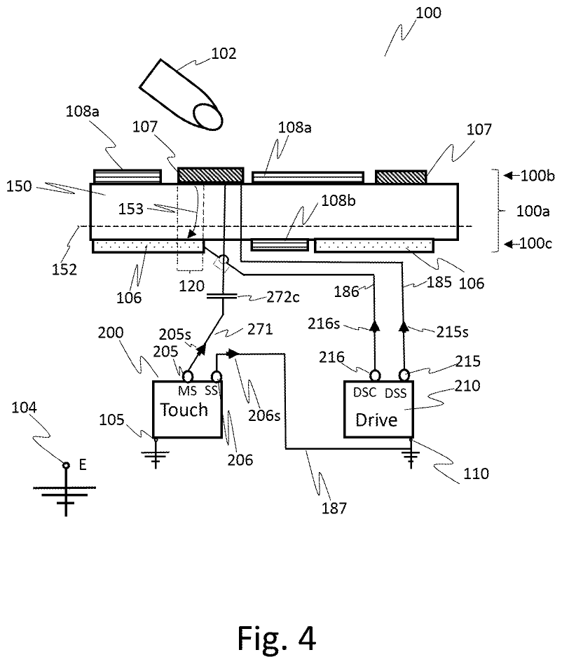

Turning to FIG. 4, in an embodiment, the isolator 272 of the of the touch connection 271 is an isolation capacitor 272c. Isolation capacitor 272c is a capacitor 272c that has a suitably large value to keep the voltage of the segment display electrode (which is essentially an electrode of a capacitor) high and not hamper the operation of the measurement unit 200, as is understood from a basic voltage division over a series connection of capacitors. Values for the isolation capacitor capacitance may be a capacitance of at least 5 μF. According to another embodiment, the isolation capacitor capacitance is between 1 μF and 1 μF. According to yet another embodiment, the isolation capacitor capacitance is between 10 μF and 100 nF. According to yet another embodiment, the isolation capacitor capacitance is between 100 μF and 10 nF.

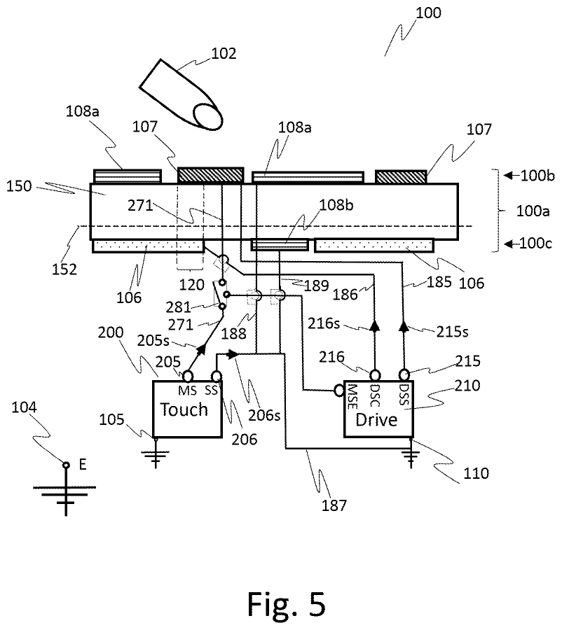

Turning to FIG. 5, in an embodiment, the first patterned conductor layer 100b on a first side of the emissive layer 150 of the touch display 100 comprises a first fill area 108a, and the touch display 100 comprises a first fill connection 188 arranged to connect the shielding voltage signal 206s to the first fill area 108a. As already defined above, a fill area is an area in the patterned conductor layer that is arranged to make the display optically more uniform and that has no direct light producing or touch detection purpose as it is not arranged to be fed with a segment driving signal 215s or a common driving signal 216s. However, by arranging a shield signal to the first fill area 108a, the parasitic nature of the fill area 108a is diminished, and any water or other environmental exposure on the fill area is also diminished, increasing the likelihood of correct touch sensing from the segment display electrode 107 considerably. The first patterned conductor layer 100b may comprise one or more first fill areas 108a. The touch display 100 may also comprise one or more first fill connections 188.

Similarly, in an embodiment, the second patterned conductor layer 100c on a second side of the emissive layer 150 of the touch display comprises a second fill area 108b, and the touch display 100 comprises a second fill connection 189 arranged to connect the shielding voltage signal 206s to the second fill area 108b. Purpose of the fill areas on the second patterned conductor layer 100c is similar to the ones in the first patterned conductor layer 100b. However, as the common display electrodes 106 can serve many segment display electrodes 107, the need for a second fill area is not, from the standpoint of optical uniformity of the layer, not as major as with the first patterned conductor layer 100b. As the first patterned conductor layer and second patterned conductor layer are very close to one another (separation due to the possible first and second dielectric layers and the emissive layer 150 may only be 1000 nm-2000 nm), to decouple the second fill area from the touch detection arranged with the segment display electrodes 107 by arranging a shield signal also to the side of the common display electrodes 106 is advantageous. This also improves the water immunity of the touch display 100. The second patterned conductor layer 100c may comprise one or more second fill areas 108b. The touch display 100 may also comprise one or more second fill connections 189.

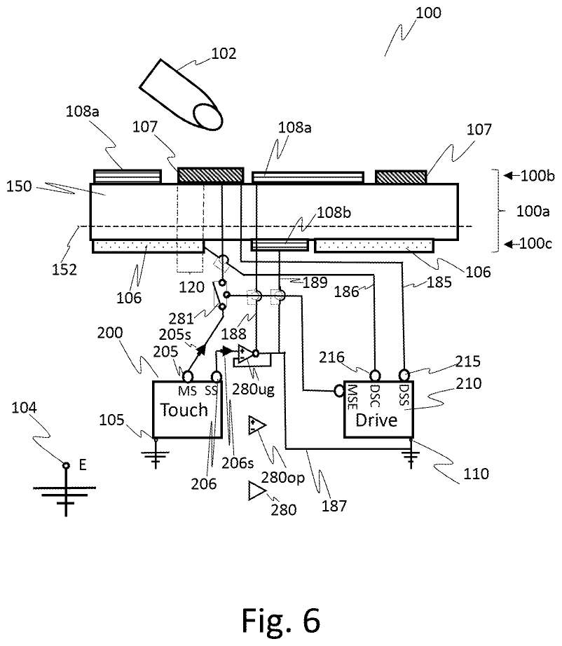

Next referring to FIG. 6, in an embodiment, the touch display 100 comprises an amplifier 280 arranged to amplify the shielding voltage signal 206s.

Still referring to FIG. 6, the touch display 100 comprises an operational amplifier 280op arranged to amplify the shielding voltage signal 206s. Operational amplifiers 280op are advantageous circuit elements that can facilitate different electrical functions with simple peripheral circuit elements to adjust e.g. their amplification characteristics. Circuit topologies utilising operational amplifiers to achieve a certain amplification are well known in the art.

In an embodiment, and as shown configured in FIG. 6, the touch display 100 comprises an operational amplifier 280ug arranged as a unity gain buffer and arranged to lessen the power drawn by the shielding voltage signal 206s from the touch measurement unit 200. In a unity gain configuration, input node of the operational amplifier is connected to a non-inverting input (+) of the operational amplifier 280ug, and an inverting input (−) of the operational amplifier is connected with a low-impedance or a galvanic connection to an output node of the operational amplifier.

In an embodiment, the shield connection 187 comprises an amplifier 280 arranged to amplify the shielding voltage signal 206s.

In an embodiment, the shield connection 187 comprises an operational amplifier 280op arranged to amplify the shielding voltage signal 206s.

In an embodiment, the shield connection 187 comprises an operational amplifier 280ug arranged as a unity gain buffer and arranged to lessen the power drawn by the shielding voltage signal 206s from the touch measurement unit 200.

In an embodiment, an amplifier 280 may be arranged to the first fill connection 188 or to the second fill connection 189, or both.

In an embodiment, an operational amplifier 280op may be arranged to the first fill connection 188 or to the second fill connection 189, or both.

In an embodiment, an operational amplifier 280ug may be arranged as a unity gain buffer and arranged to lessen the power drawn by the shielding voltage signal 206s from the touch measurement unit 200, the operational amplifier 280ug arranged to the first fill connection 188 or to the second fill connection 189, or both.

In an embodiment, the first patterned conductor layer 100b of the touch display 100 comprises one or more segment display electrodes 107, the driving electronics unit 210 comprises one or more segment driving nodes 215, and the touch measurement unit 200 comprises one or more touch measurement nodes 205. Furthermore, the touch display 100 comprises one or more segment connections 185 arranged to connect the one or more segment display electrodes 107 and the one or more segment driving nodes 215. The touch display 100 also comprises one or more touch connections 271 between one or more touch measurement nodes 205 and the one or more segment display electrodes 107 arranged to provide a touch measurement signal 205s for touch detection to the one or more segment display electrodes 107. This is to highlight that in a practical touch display, there are often many segment display electrodes for information showing purposes that need to be equipped with touch detection functionality. One example is e.g. a pin pad display where each of the numbers displayed (0-9) may also be arranged with a touch sensing functionality according to the present invention. However, not all segment display electrodes 107 of a touch display 100 need to be arranged with a touch sensing functionality. In other words, some segment display electrodes 107 may be for light emission only, and thus may be void of touch connections 271 between touch measurement nodes 205 and segment display electrodes 107 arranged to provide a touch measurement signal 205s for touch detection to the segment display electrodes 107.

In an embodiment, the second patterned conductor layer 100c of the touch display 100 comprises one or more common display electrodes 106, the driving electronics unit 210 comprises one or more common driving nodes 216, and the touch display 100 comprises one or more common connections 186 arranged to electrically connect the one or more common display electrodes 106 and the one or more common driving nodes 216. This is to highlight that the touch display 100 may comprise also one or more common display electrodes.

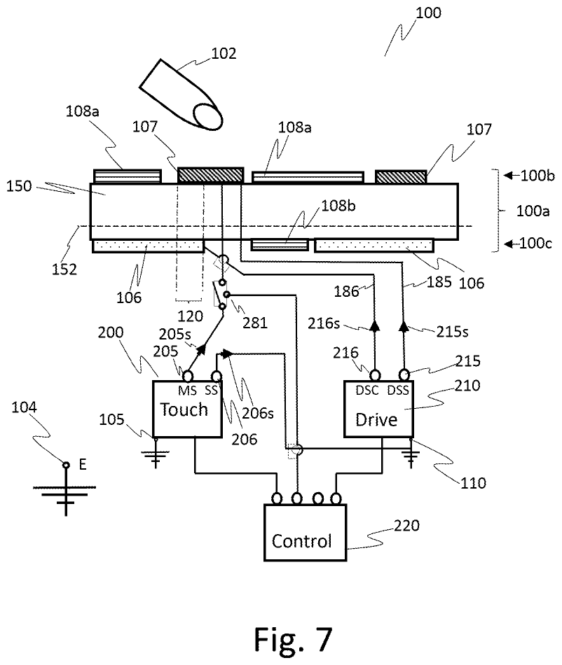

Referring to FIG. 7, according to an embodiment, a touch display 100 comprises a control unit 220 that is arranged to control the operation of driving electronics unit 210, touch measurement unit 200 and the switch 281.

Referring still to FIG. 7, according to another embodiment, a touch display 100 comprises a control unit 220 that controls the operation of driving electronics unit 210, touch measurement unit 200 and the switch 281. The control unit 220 is arranged to control the driving electronics unit 210. The driving electronics unit 210 is arranged, as controlled by the control unit 220, to produce a segment driving signal 215s to the segment display electrode 107 and a common driving signal 216s to the common display electrode 106 for light emission during light emission periods. Similarly, the touch measurement unit 200 is arranged, as controlled by the control unit 220, to produce, during touch measurement periods, the touch measurement signal to the segment display electrode 107 for touch detection. The touch measurement unit 200 is also arranged, as controlled by the control unit 220, to produce, during touch measurement periods, the shielding voltage signal 206s. Also the switch 281, as controlled by the control unit 220, is arranged to be set into an open state during light emission periods and arranged to isolate the segment driving signal 215s of the segment display electrode 107 from the touch measurement unit 200, and arranged to be set into a closed state during touch measurement periods to connect the touch measurement signal 205s for touch detection to the segment display electrode 107.

Thus, also in this embodiment, the operation of the touch display 100 may be arranged between light emission periods during which light emission from segment and common display electrodes occurs, and touch measurement periods during which touch detection and touch measurement occurs. Light emission periods and touch measurement periods alternate and repeat in time. During the touch measurement period, there is at least one period with no light emission. Similarly, the during light emission period, there is at least one another period with no touch measurement. A light emission period may be separated from a subsequent touch measurement period by a first guard period. A touch measurement period may also be separated from a subsequent light emission period by a second guard period. During each of the light emission periods, a segment driving signal 215s is arranged to one or more segment display electrodes through one or more segment driving nodes 215, and a common driving signal 216s is arranged to one or more common display electrodes through one or more common driving nodes 216. This produces light emission from the emissive layer, from the regions where one or more segment display electrodes and one or more common display electrodes overlap. During each of the touch measurement periods, a touch measurement signal is arranged to one or more touch measurement nodes 205 from which it is arranged to one or more segment display electrodes 107 for touch sensing. During each of the touch measurement periods, a shielding voltage signal is also arranged to one or more shield signal nodes 206 from which it may be arranged to the display electronics ground node 110, and in some embodiments e.g. to the fill areas 108a and 108b.

In an embodiment, the first patterned conductor layer 100b and the second patterned conductor layer 100c of the thin film display element 100a of the touch display 100 are transparent. This provides a transparent display, e.g. an AC driven TFEL display, as the other thin film layers of the display are by their nature essentially transparent. Purpose, advantage and features of the transparency in the present application are already discussed above.

In an embodiment, the thin film display element 100a of the touch display 100 is transparent. Naturally, for most window laminated purposes, transparency is an obligatory requirement, but e.g. for some small sized side window installations in, for example, motor vehicles, also non-transparent displays may be used.

Just as with the prior art touch display 100′, the touch display 100 may comprise a power unit 240 that is arranged to supply power to the operations of the touch display 100. Further, the touch display 100 may comprise an interface unit 235 which communicates in a two-way sense with both input (to obtain data on what information to display) and output (to express what touch events have been sensed) with the system units external to the touch display 100 through some communication bus 230. In the present application, an interface unit 235 means both the physical connector like an RJ45 connector, and the related two-way communication protocol like CanBUS, RS485, SPI or I2C. Similarly, communication bus 230 means both the conductors and cabling of the communication bus 230, and the logical protocol like CanBUS or RS485 carried by the conductors and cabling. The operation of the touch display can be controlled by a control unit 220, which is arranged in connection with other units like touch measurement unit 200, driving electronics unit 210, interface unit 235 and power unit 240 with suitable conductor or conductors as shown in FIG. 1.

It is evident for a skilled person that the touch measurement unit 200, driving electronics unit 210, control unit 220, interface unit 235 and power unit 240 can be separate physical entities with their own housing or real estate in a printed circuit board and realized with discrete circuit components. Alternatively or additionally, the touch measurement unit 200, driving electronics unit 210, control unit 220, interface unit 235 and/or power unit 240 can be arranged with known integrated circuit technologies into a semiconductor chip, and/or realized at least partially through e.g. ASIC, FPGA, SoC and/or microprocessor and memory technologies.

The invention has been described above with reference to the examples shown in the figures. However, the invention is in no way restricted to the above examples but may vary within the scope of the claims.

1. A touch display comprising:
a thin film display element extending substantially along a base plane defining a lateral extension of the thin film display element, the thin film display element comprising:
an emissive layer arranged to emit light upon an excitation voltage is arranged over the emissive layer,
a first patterned conductor layer on a first side of the emissive layer the first patterned conductor layer comprising a segment display electrode,
a second patterned conductor layer on a second side of the emissive layer opposite the first side of the emissive layer, the second patterned conductor layer comprising a common display electrode at least partly laterally overlapping the segment display electrode;
the touch display comprising:
a driving electronics unit, the driving electronics unit comprising:
a segment driving node arranged to produce a segment driving signal to the segment display electrode,
a common driving node arranged to produce a common driving signal to the common display electrode, and
a driving electronics ground node;
a touch measurement unit, the touch measurement unit comprising:
a touch measurement node arranged to provide a touch measurement signal for touch detection,
a shield signal node arranged to provide a shielding voltage signal arranged to decrease capacitive coupling, and
a touch ground node;
the touch display comprising:
a segment connection arranged to electrically connect the segment display electrode and the segment driving node,
a common connection arranged to electrically connect the common display electrode and the common driving node, and
an earth ground node;
wherein the touch display comprises:
a touch connection between the touch measurement node and the segment display electrode, the touch connection arranged to provide a touch measurement signal for touch detection to the segment display electrode, the touch connection comprising an isolator arranged to isolate the segment driving signal of the segment display electrode from the touch measurement unit, and
a shield connection between the shield signal node of the touch measurement unit and the driving electronics ground node of the driving electronics unit arranged to connect the shielding voltage signal to the driving electronics ground node.

2. A touch display according to claim 1, wherein the isolator of the touch connection comprises a switch.

3. A touch display according to claim 1, in that wherein the isolator of the touch connection comprises a switch which is arranged be set into an open state during light emission periods and arranged to isolate the segment driving signal of the segment display electrode from the touch measurement unit during light emission periods, and
a closed state during touch measurement periods and arranged to connect the touch measurement signal for touch detection to the segment display electrode during touch measurement periods.

4. A touch display according to claim 2, wherein the touch display comprises a control unit arranged to control the driving electronics unit the touch measurement unit and the switch.

5. A touch display according to claim 2, wherein the touch display comprises a control unit such that:
a) the driving electronics unit as controlled by the control unit, is arranged to produce the segment driving signal to the segment display electrode and the common driving signal to the common display electrode for light emission during light emission periods;
b) the touch measurement unit, as controlled by the control unit is arranged to produce, during touch measurement periods:
the touch measurement signal to the segment display electrode for touch detection, and
the shielding voltage signal; and
c) the switch, as controlled by the control unit, is arranged to be set:
into an open state during light emission periods and arranged to isolate the segment driving signal of the segment display electrode from the touch measurement unit, and
into a closed state during touch measurement periods to connect the touch measurement signal for touch detection to the segment display electrode.

6. A touch display according to claim 1, wherein the isolator of the touch connection comprises a capacitor with a capacitance value of:
at least 5 μF; or
between 1 μF and 1 μF; or
between 10 μF and 100 nF; or
between 100 μF and 10 nF.

7. A touch display according to claim 1, wherein
the first patterned conductor layer on the first side of the emissive layer comprises a first fill area, and
the touch display comprises a first fill connection arranged to connect the shielding voltage signal to the first fill area.

8. A touch display according to claim 1, wherein
the second patterned conductor layer on the second side of the emissive layer comprises a second fill area, and
the touch display comprises a second fill connection arranged to connect the shielding voltage signal to the second fill area.

9. A touch display according to claim 1, wherein
the touch display comprises an amplifier arranged to amplify the shielding voltage signal; or
the touch display comprises an operational amplifier arranged to amplify the shielding voltage signal; or
the touch display comprises an operational amplifier arranged as a unity gain buffer arranged to lessen the power drawn by the shielding voltage signal from the touch measurement unit.

10. A touch display according to claim 1, wherein:
the first patterned conductor layer comprises one or more segment display electrodes,
the driving electronics unit comprises one or more segment driving nodes,
the touch measurement unit comprises one or more touch measurement nodes,
the touch display comprises one or more segment connections arranged to electrically connect the one or more segment display electrodes and the one or more segment driving nodes, and
the touch display comprises one or more touch connections between the one or more touch measurement nodes and the one or more segment display electrodes arranged to provide touch measurement signals for touch detection to the one or more segment display electrodes.

11. A touch display according to claim 1, wherein:
the second patterned conductor layer comprises one or more common display electrodes,
the driving electronics unit comprises one or more common driving nodes, and
the touch display comprises one or more common connections arranged to electrically connect the one or more common display electrodes and the one or more common driving nodes.

12. A touch display according to claim 1, wherein:
the first patterned conductor layer and the second patterned conductor layer are transparent; or
the thin film display element is transparent.
